(19) United States
(12) Patent Application Publication
(10) Pub. No.: US 2004/0074581 A1
(43) Pub. Date: Apr. 22, 2004

(54) Apparatus and method for assembling electronic components to a printed circuit board

(75) Inventors: Jonathan S. Hardy, Deep River, CT (US); Gregory S. Voelker, East Hampton, CT (US)

Correspondence Address: ALIX YALE & RISTAS LLP, 750 MAIN STREET, SUITE 1400, HARTFORD, CT, 06103, US

(73) Assignee: Whelen Engineering Company, Inc.

(21) Appl. No.: 10/273,957

(22) Filed: Oct. 18, 2002

(51) Int. Cl. B32B 31/00; B05C 11/00; C09J 5/04

(52) U.S. Cl. 156/64; 156/350; 118/264; 118/268

(57) ABSTRACT

A component placement machine is provided with an activator application station for application of an adhesive activator to an appropriate surface of a surface-mount component. The application station includes an activator reservoir and wick that provide activator to a porous pad by capillary action. The reservoir and wick are substantially sealed from the environment to prevent unnecessary evaporation of the activator. The component placement machine operating program is modified to include the steps of bringing a component to the applicator station, dabbing the component surface against the applicator pad and returning the component to its installation path. A second adhesive component may be pre-applied to the PCB by an adhesive dispenser as is known in the art. The two-part chemically activated adhesive permits rapid low-temperature curing. The invention allows cost-effective fixture of temperature-sensitive surface-mount components to a PCB.

### BACKGROUND OF THE INVENTION

1. Field of the Invention

This invention relates generally to printed circuit board assembly and more particularly to a method and apparatus for mounting temperature-sensitive electronic components to a printed circuit board.

2. Description of the Related Art

Electronic component placement machines, sometimes called “pick and place” machines, are known. Pick and place machines are used to load electronic components or parts onto a printed circuit board (PCB) for subsequent processing such as soldering the chip components to PCB traces. A typical pick and place machine includes a platform for supporting the PCB, adjacent to which are provided a plurality of part feeders. The electronic components may be provided on reels of tape supplied to the feeders or as stick or bulk feeders. Components may also be provided in trays.

The typical pick and place machine generally has a head moveable in four dimensions with respect to the PCB. One or more grippers may be present for holding the electronic components. Grippers may be provided with holding power such as suction or mechanical means for grasping electronic components. In order to manufacture high quality PCB assemblies in a cost-effective manner, it is necessary to assemble the electronic components to the circuit board panel at high speed and with great precision.

Typically, the electronic components must be secured to the PCB prior to an additional step such as soldering. Many electronic components utilize metal leads that provide a mechanical connection to the PCB by clinching. The clinched leads may also provide subsequent electronic connection to the PCB. Other components lack these extending metallic legs and are called surface-mount components. Surface-mount components are typically glued to the PCB prior to the soldering step. Many of the typical adhesives utilized for joining surface-mount components to a PCB are heat-activated or require long duration heat curing. This typically requires the entire PCB with its surface-mounted components to be heated to cure the adhesive.

A subsequent step of heating is typically applied for the purpose for establishing soldered connections. The heat for the purpose of soldering is typically applied only to fine metallic leads protruding from the surface mount components and solder-coated lands beneath the leads. This locally applied heat is typically of very short duration. The brevity of the solder heating step in combination with the small sectional area of the lead, protect the associated component from over-heating during the soldering step.

Many electronic components, and in particular recently developed high-output light-emitting diodes (LEDs), are temperature sensitive, e.g., extended duration high-temperature curing will degrade these components. Lowering the temperature and extending the time for heat curing of adhesive is unacceptable since cost efficiency requires rapid throughput during the assembly process.

Therefore, there is a need in the art for a method and apparatus for securing temperature-sensitive electronic components to a PCB in a cost-effective manner.

### SUMMARY OF THE INVENTION

According to a first embodiment of a first aspect of the present invention, a pick and place machine is equipped to apply the activator of a two part adhesive to the bottom surface of a surface-mount component immediately prior to positioning the component on a PCB. According to another aspect of the present invention, a glue dispenser applies the second component of the adhesive to the PCB before the PCB is moved into the position where it will receive the surface mount components.

According to the first embodiment of the first aspect of the invention, a pick and place machine is modified to support a reservoir of adhesive activator and a wick, which by capillary action continuously supplies activator to saturate an application pad. The pick and place machine is programmed to press a mounting surface of the surface-mount component to the pad prior to applying the component to the PCB. The operating software of the pick and place machine is modified to include the steps of positioning the surface-mount component over the pad, pressing or “dabbing” the component on the pad to apply activator and returning the surface-mount component to its installation path. The installation path positions the component in the correct orientation and location relative to the PCB. The pick and place machine then applies the mounting surface of the component to the PCB. Application of the mounting surface to the PCB combines the two components of the adhesive such that the adhesive is “activated”.

High output LEDs generate significant internal heat. This internal heat must be dissipated or it will accumulate and destroy the LED. The PCBs for surface mount LEDs are provided with pads (known in the art as “thermal spreaders”) of thermally conductive material (typically copper) to which the mounting surface of the component will be adhered. To ensure adequate thermal transfer from the component to the pad, the adhesive bond between a surface mount LED and the PCB must be thermally conductive. Certain classes of adhesives manufactured by Loctite Corporation of Rocky Hill, Conn. have the requisite thermal conductivity, strength, fast cure time and low curing temperatures to be appropriate for use in conjunction with the first embodiment of present invention. One such adhesive is Loctite® 3873 thermally conductive adhesive and Loctite® 7387 Depend® Activator. The 7387 Depend® Activator includes several volatile components, the evaporation of which must be controlled. Loctite teaches that the 7387 Depend® Activator may be applied with a brush-top bottle.

Once activated, the adhesive will set quickly, e.g., in approximately 5 minutes and at relatively low temperatures. While total cure times to achieve maximum strength may be as long as 24 hours, the set strength of the adhesive is sufficient to permit handling of the PCB. A fast set time results in increased through put that improves the cost efficiency of the assembly process. The activators for such fast-set chemically activated adhesives tend to be volatile. Thus, it is necessary to develop an apparatus and method of activator application that minimizes exposure of the activator to the ambient environment. Further, to ensure production of consistently reliable PCB assemblies, possible sources of PCB contamination must be minimized. Consequently, the activator application method must minimize opportunities for activator to end up in the wrong place, i.e., the application method should ideally apply activator only to that portion of the surface-mount component that will be adhered to the PCB.

According to the first aspect of the first embodiment of the invention, the volatile activator is contained in a sealed reservoir and the wick is contained within a guide tube. Further, the pad to which the surface-mount component will be dabbed is ideally configured to provide an application surface closely related to the adhesive-receiving portion of the surface mount component. Supporting the wick in a tubular holder such that the end of the wick protrudes above the holder may provide one embodiment of such a pad. The pad may be renewed periodically by raising the wick above the holder and trimming the wick perpendicular to its length. Extra length of wick may be coiled in the reservoir for this purpose.

An object of the present invention is to provide a new and improved method and apparatus for securing temperature-sensitive surface-mount components to a PCB.

Another object of the present invention is to provide a new and improved method and apparatus for applying a fast-cure, low-temperature, chemically activated adhesive between a surface-mount component and a PCB.

A further object of the invention is to provide a new and improved method and apparatus that allows for cost effective production of PCB assemblies including temperature-sensitive components.

### BRIEF DESCRIPTION OF THE DRAWINGS

These and other objects, features, and advantages of the invention will become readily apparent to those skilled in the art upon reading the description of the preferred embodiments, in conjunction with the accompanying drawings, in which:

FIG. 1 is a photographic view of a portion of a first embodiment of a pick and place machine including an activator reservoir, wick and application pad according to a first aspect of the present invention;

FIG. 2 shows a placement head of the pick and place machine of FIG. 1 retrieving a component from a part feeder;

FIG. 3 illustrates the placement head positioning the component over the activator application pad;

FIG. 4 illustrates the placement head dabbing activator on the bottom surface of the surface-mount component;

FIG. 5 is a flow chart illustrating the steps added to the operational software of a pick and place machine to incorporate the illustrated embodiment of the invention; and

FIGS. 6A through 6C are end, side and top views, respectively, partly in phantom and partly broken away, of an exemplary wick support.

### DETAILED DESCRIPTION OF THE PREFERRED EMBODIMENT

A preferred embodiment of the invention can be implemented using a pick and place machine such as that manufactured by Contact Systems, Inc. of Danbury, Conn. The configuration and operation of pick and place equipment are known to those skilled in the art and will be discussed in detail only as they relate to aspects of the present invention.

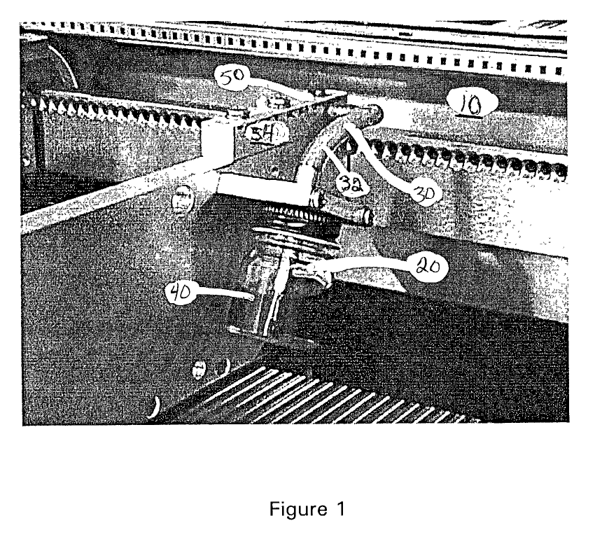

The pick and place machine 10 is modified to include an activator reservoir 20 and wick 32 that supply adhesive activator 40 to an application pad 50 as shown in FIG. 1. The illustrated pick and place machine 10 includes a movable head 12 that carries a vacuum activated gripper 14.

Many adhesive activators are volatile, e.g., have a tendency to rapidly vaporize into the ambient atmosphere. Aside from a waste of valuable activator, such evaporation presents potential hazards for personnel and the possibility of corrosion or contamination of nearby surfaces. Therefore, as shown in FIG. 1 the reservoir 20 and wick 32 are sealed so as to be substantially isolated from the ambient atmosphere. In the illustrated preferred embodiment, the reservoir 20 comprises a sealed jar, which may be opened to fill with more activator 40. The wick 32 is surrounded by a guide tube 30 that is impervious to the activator.

The reservoir 20 and wick 32 continuously supply activator to an activator application pad 50 by capillary action. This method has the advantage of simplicity and includes no moving parts. The activator application station 52 comprises a rigidly mounted application pad 50 to which a surface-mount component is dabbed by the pick and place equipment 10. The term “dabbing” as used in this application and claims refers to a step of gently pressing an appropriate surface of the surface-mount component 60 against a pad 50 moistened with adhesive activator 40. Preferably, the pad 50 is configured to deposit an appropriate pattern or shape of adhesive activator 40 to the surface-mount component 60. Such a pattern of activator may include the entire bottom surface of the component 60 or only a portion thereof.

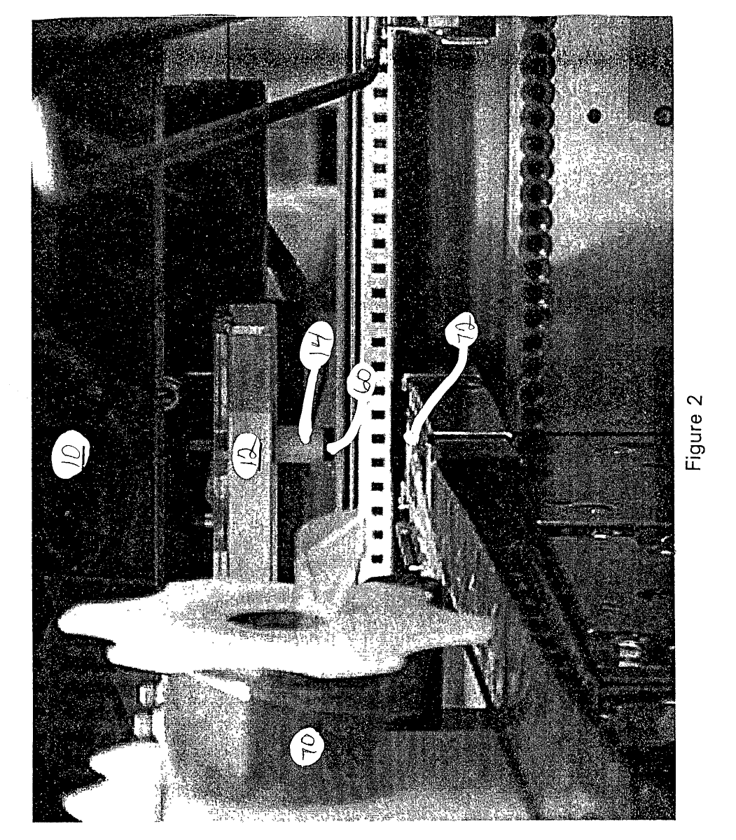

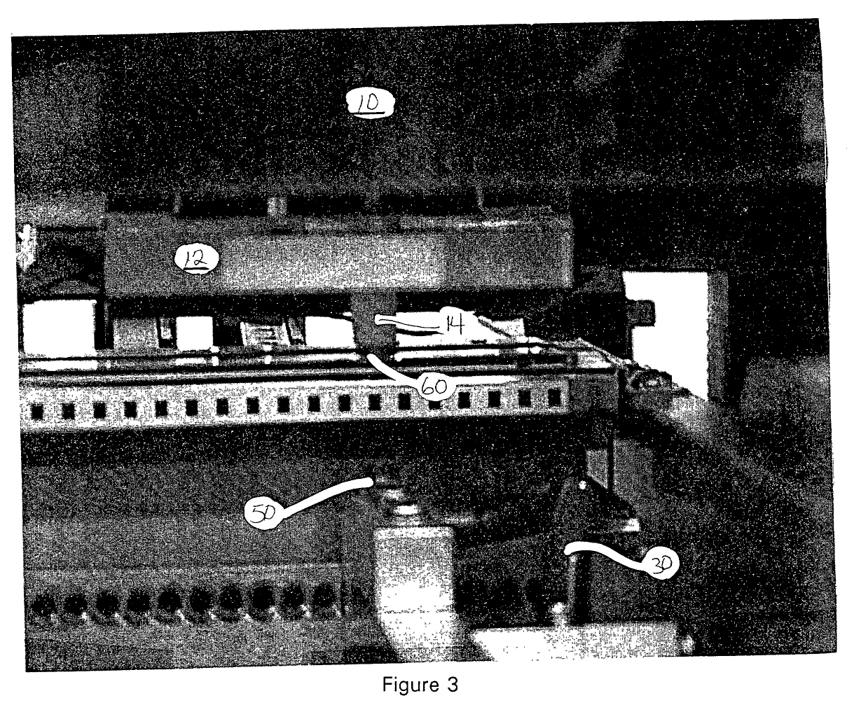

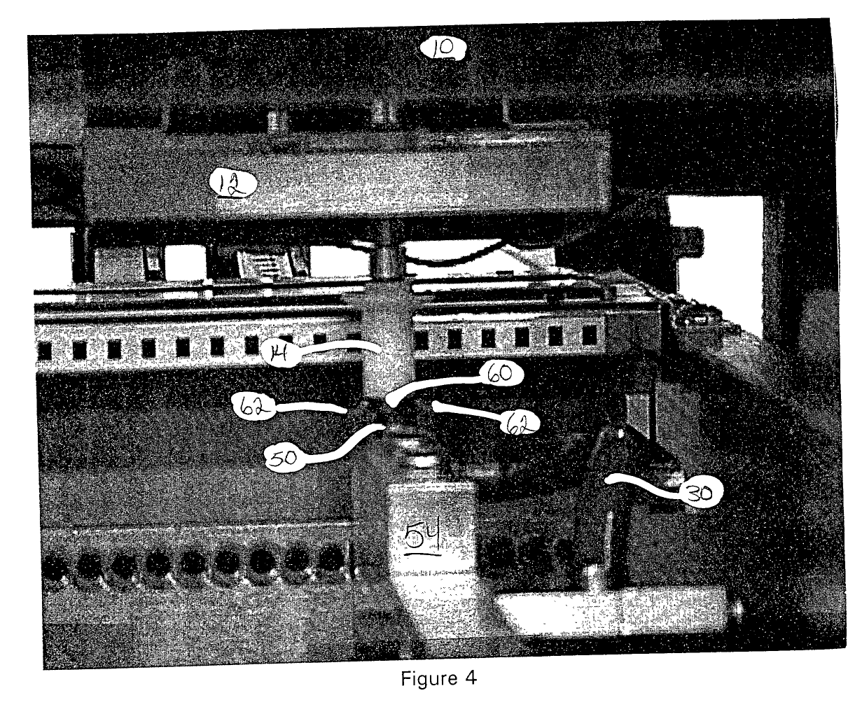

The pick and place machine is designed to retrieve electronic components from feeders, accurately identify the position of the component and apply the component to a precise position and orientation on a PCB. Therefore, the pick and place machine 10 includes the necessary mechanisms and accuracy to properly orient a surface-mount component 60 over the activator application pad 50 and dab activator 50 to a portion of the surface-mount component as illustrated in FIGS. 2-4. FIG. 2 illustrates the positions of the head 12 and gripper 14 after retrieving a component 60 from a feeder 72. A reel 70 is used to accumulate the tape that carried the component 60. FIG. 3 illustrates the head 12, gripper 14 and gripped component 60 positioned over the activator application pad 50. FIG. 4 illustrates the head 12, gripper 14 positioned to press a bottom surface of the gripped component 60 against the activator application pad 50. Metallic leads 62 can be seen protruding laterally from the component 60 shown in FIG. 4.

The operating program of the pick and place machine 10 is modified to include the additional steps of:

a) diverting the component from its installation path;

b) positioning the component over the activator application pad;

c) pressing the mounting surface of the component to the pad; and

d) returning the component to its usual installation path.

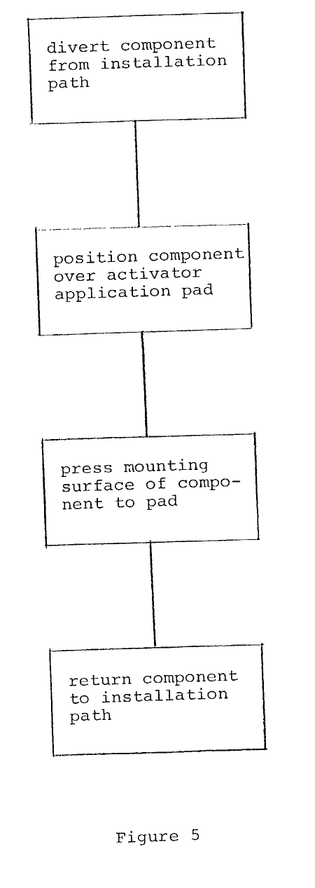

These steps are illustrated in the flow chart of FIG. 5.

The second, non-activator, component of the chemically activated adhesive may be applied in a preliminary step by for example, a glue dispenser (not shown) attached to the pick and place equipment 10 as is known in the art. Dots of adhesive can be precisely arranged on the PCB (not shown) immediately prior to mounting of the surface-mount component 60. The described method and illustrated apparatus in accordance with the present invention permits use of adhesives that are readily available and rapidly set at room temperature. Advantageously, the invention requires no moving parts and may be implemented by simple modifications to the physical equipment combined with the inclusion of additional software steps in the operating routine of the pick and place machine 10. Modification of software is extremely cost efficient. The resulting apparatus cost effectively provides high quality PCB assemblies with temperature-sensitive components that have not been degraded by a high-temperature adhesive-curing step.

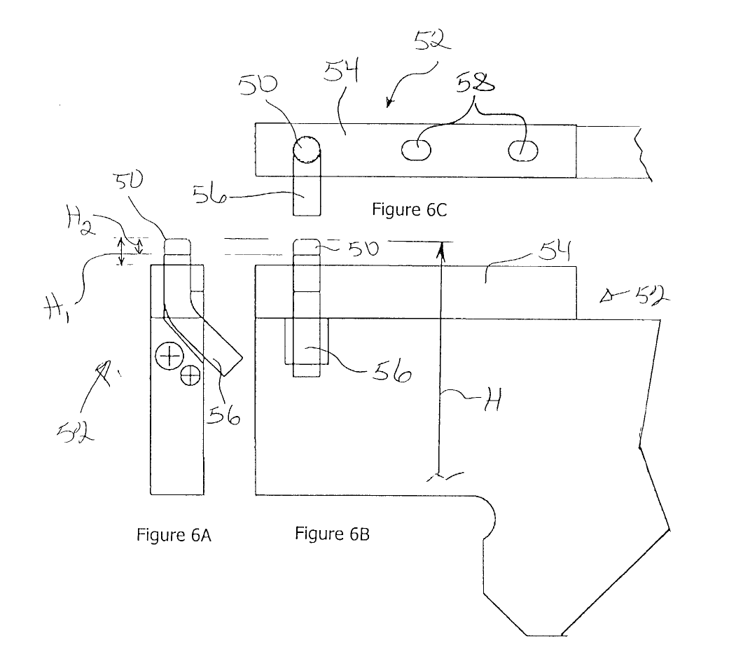

FIGS. 6A through 6C illustrate an exemplary embodiment of an activator application station 52. The application station may be arranged in the “pick area” of the pick and place machine 10. The pick area is where the reels and/or bins of parts are arranged and where the head of the pick and place machine retrieves parts for subsequent placement. In the pick area, the pick and place machine is programmed to retrieve parts at a particular height, e.g., vertical position relative to the frame of the machine 10. To avoid complicating the dabbing maneuver, it is expedient to arrange the pad 50 at a height H that is substantially equivalent to the height at which the gripper 14 typically retrieves a part from the reel or bin. FIG. 6B illustrates that the applicator pad 50 is arranged at a height H compatible with the machine configuration. The height H of the pad 50 may be adjusted to produce a desired pressure between the component 60 being dabbed and the pad. The dabbing pressure should apply activator to the mounting surface of the component 60 sufficient to result in a secure bond between the component 60 and the PCB.

The wick 32 is supported in a 45° elbow 56 mounted to a block 54 whose position is adjustable relative to the path of the head 12 and gripper 14 by means of oversize mounting holes 58. The lateral position of the applicator pad 50 is adjusted to coincide precisely with a programmed dabbing position of the part 60 in the gripper 14.

FIGS. 6A and 6B illustrate that the illustrated embodiment of the applicator pad 50 is in fact the end of the wick 32. A suitable wick material is wool felt, although other materials may occur to one of skill in the art. It may be necessary to renew the end of the wick 32 comprising the activator pad due to contamination or wear. The present invention provides for this eventuality by coiling extra length of wick 32 in the reservoir 20. The wick 32 is raised above the elbow 56 and trimmed perpendicular to its length. A collar (not shown) or other gage having a height H₁ may be used to ensure that the trimmed wick end surface protrudes a pre-determined height H₂ above the elbow 56. The gage also aids in ensuring a uniform, horizontal wick end surface. The position of the reservoir 20, the path of the guide tube 30 and the 45° elbow permit extraction of additional wick from the elbow when necessary, while maintaining sufficient friction on the wick 32 to present a firm surface to the component being wetted with activator.

While a preferred embodiment of the foregoing invention has been set forth for purposes of illustration, the foregoing description should not be deemed a limitation of the invention herein. Accordingly, various modifications, adaptations and alternatives may occur to one skilled in the art without departing from the spirit and the scope of the present invention.

What is claimed is:

1. A component placement machine comprising
an activator application station including a porous surface substantially saturated with activator; and
means for touching a portion of a component to said porous surface, whereby activator from the porous surface is applied to the portion of the component touched to the porous surface.

2. The component placement machine of claim 1, wherein the activator application station further comprises a reservoir of activator substantially sealed from the ambient environment and a wick for carrying activator from said reservoir to said porous surface by capillary action, said wick being surrounded by a guide tube to substantially isolate said wick from the ambient environment.

3. The component placement machine of claim 1, wherein the porous surface is configured in a shape substantially similar to a shape of the portion of the component to which said activator is to be applied.

4. The component placement machine of claim 1, comprising means for applying a second adhesive component to a PCB.

5. The component placement machine of claim 1, wherein said porous surface comprises an end surface of said wick.

6. A method for securing a component to a PCB utilizing a component placement machine comprising a placement head which retrieves a component from a feeder and precisely positions the component on a PCB, said method comprising the steps of:
diverting the placement head and associated surface mount component from an installation path;
moving the placement head to apply an activator to a selected exterior surface portion of the component; and
returning the placement head and associated surface mount component to the installation path.

7. The method of claim 6, comprising the steps of:
applying a second adhesive component to the PCB at said predetermined component location; and
moving the placement head to place the component on the PCB at said predetermined component location,
wherein said placement of the surface mount component combines said activator with the second adhesive component to form a chemically activated adhesive.

8. The method of claim 6, comprising:
providing a software program for the component placement machine so that said component placement machine carries out the steps of diverting, moving and returning.
